(19) United States
(12) Patent Application Publication
(10) Pub. No.: US 2015/0379978 A1
(43) Pub. Date: Dec. 31, 2015

(54) Electromagnetic Pickup for Stringed Instruments

(71) Applicant: Changsoo Jang, San Jose, CA (US)

(72) Inventor: Changsoo Jang, San Jose, CA (US)

(21) Appl. No.: 14/315,336

(22) Filed: Jun. 26, 2014

(51) Int. Cl. G10H 3/18

(52) U.S. Cl. CPC G10H 3/181

(57) ABSTRACT

An electromagnetic pickup for electric guitars has one or two dual-coil assemblies wherein an inner coil is wound around a bobbin and then an outer coil around the inner coil. In the dual-coil assembly the inner coil replaces the entire or part of wall space of pole piece holes in a plastic molded bobbin. The outer and inner coils in the dual-coil assembly are electrically connected in-phase to produce single coil pickup sound. The outer coil is connected to the coil in the other pole piece/bobbin/coil assembly out-of-phase to generate humbucking pickup sound.

### REFERENCE CITED

### U.S. Patent Documents

U.S. Pat. No. 2,896,491, July/1959, Lover

U.S. Pat. No. 4,364,295, December/1982, Lawrence

### BACKGROUND OF THE INVENTION

An electromagnetic pickup (pickup, hereinafter) converts the vibrations of plucked strings of an electric guitar, which are located on top of the pickup where electromagnetic fields are formed, into an electrical signal. In general a single coil pickup (SC pickup, hereinafter) comprises of a set of pole pieces made of magnetic or ferromagnetic materials, magnetic wire coil, bobbin plates, and lead wires. The SC pickup is sensitive to external magnetic fields created by speakers, power transducers, fluorescent light sources and so on. An exposure to such magnetic fields causes undesired humming noise.

The most popular hum-cancelling (hum-bucking) pickup was introduced by Lover (U.S. Pat. No. 2,896,491 granted in 1959). The pickups built according to this invention have been called PAF (Patent Applied For). In this document the PAF style hum-bucking pickup is referred to simply as the HB pickup, hereinafter. The HB pickup is in principle a combination of two SC pickups. Two pole piece/bobbin/coil assemblies are put together side-by-side and connected both electrically and magnetically out-of-phase. This arrangement cancels signal sources externally radiated onto two coils while maintaining in-phase with the signal from strings.

A pickup has a unique response characteristic to string vibrations resulting in a unique tone color. Pickup tone is dependent on many parameters, which include magnet materials, pole pieces, bobbin materials and structures, magnet wire gage, magnet wire coating materials, the number of wire turns and so on. Although external factors such as guitar builds, effects pedals and amplifiers can color the tone characters to some extent, they cannot completely override the original tone of the pickup. That is why old classical pickups including the said PAF are still popular, and also, a number of different pickup products are available in the music industry.

Two most distinctive tone colors are generated from aforementioned SC and HB pickups. The SC pickup usually produces a clear and bright sound with a focus on the treble to mid-range domain, whereas the HB pickup produces a warm and thick sound with a focus on the mid-range domain. The majority of electric guitar players use both types of pickups depending on the needs. Because it is inconvenient and impractical to change guitars for different pickup sounds in the middle of performance, many guitar builders and pickup makers offer the option of “coil-tapping”, by which a guitar player can use only one of the two coils in the HB pickup, or more rarely “combining”, in which two individual SC pickups are electrically connected like one HB pickup. However, both methods do not deliver a purposed SC or HB sound very well. A coil-tapped pickup sound is typically thinner and less lively than a genuine SC pickup sound. On the other hand, a combination of two genuine SC pickups does not usually produce a good HB pickup sound defined by warmth and fullness. As a result, pickups that can produce both HB and SC sounds are hardly found.

From a set of experiments it was found that one of the most critical factors, which make the difference in sound characteristics between a genuine SC pickup and a coil-tapped HB pickup, was the space between the coil and the pole pieces and that such space in the HB pickup can be made closer to that of the SC pickup without damaging or changing the sound characteristics and form factor of the HB pickup. The details of this invention and embodiments are described in the next sections.

### SUMMARY OF THE INVENTION

This invention is about a method to wind the HB pickup to obtain a clear and bright SC-like pickup sound from one of its pole piece/bobbin/coil assemblies. At least one of the two pickup bobbins is made such that the surface of pole pieces is in contact with the innermost wires of a coil, or the distance between the two is closer than that of the traditional HB pickup. This can be made possible by eliminating or thinning the wall of pole piece holes in a molded plastic bobbin. An inner coil is wound around a bobbin such that the space occupied by the pole piece hole wall is now filled with the inner coil. An outer coil is then wound on top of the inner coil according to a designated HB winding specification. The outer coil is electrically connected to a coil wound around the other bobbin to obtain a HB pickup sound, whereas the inner and outer coils wound around the same bobbin are electrically connected in-phase to produce a SC pickup sound. In effect this invention makes the HB pickup and the electric guitar employing one or plural of them versatile in terms of tonal variations.

### BRIEF DESCRIPTION OF THE DRAWINGS

Note that the schematics used in this document are not to scale. This document assumes all the electrical connections shown in the figures follow the well-established art of HB pickup wiring (e.g., in-phase and out-of-phase wiring), and thus, phase information is not specified in the drawings. This document also assumes that all embodiments of this invention follow the known art of magnet, pole piece dispositions, and other miscellaneous items including spacers and screw holders within the HB pickup (based on Lover's patent, 1959), which have been well established, published and commercialized.

FIG. 1 illustrates a top view of SC pickup

FIG. 2 illustrates diagrams of pole set/bobbin and wire assembly of SC pickups in two popular arrangements

FIG. 3 illustrates a top view of HB pickup

FIG. 4 illustrates a diagram of pole piece/bobbin/coil assembly of HB pickup

FIG. 5 illustrates a simplified diagram of pole piece/bobbin/coil assembly

FIG. 6 illustrates simplified diagrams of traditional HB pickup bobbin assembly (left) and new HB pickup bobbin assembly proposed in the present invention (right)

FIG. 7 illustrates an example of (a) plastic molded bobbin for traditional HB pickup and (b) plastic molded bobbin for dual-coil assembly with outward wall of pole piece holes removed.

FIG. 8 illustrates examples of embodiment of the present invention onto (a) one and (b) both of pole piece/bobbin/coil assemblies of HB pickup

FIG. 9 illustrates an example of embodiment of the present invention onto HB pickup assembly with dual-coil assembly on the left side

FIG. 10 illustrates an example of lead wiring of HB pickup with dual-coil assembly on one side

### DETAILED DESCRIPTION

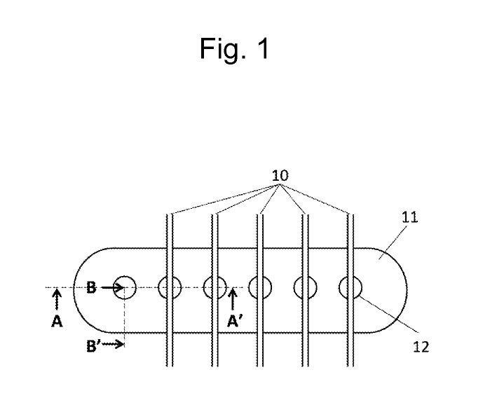

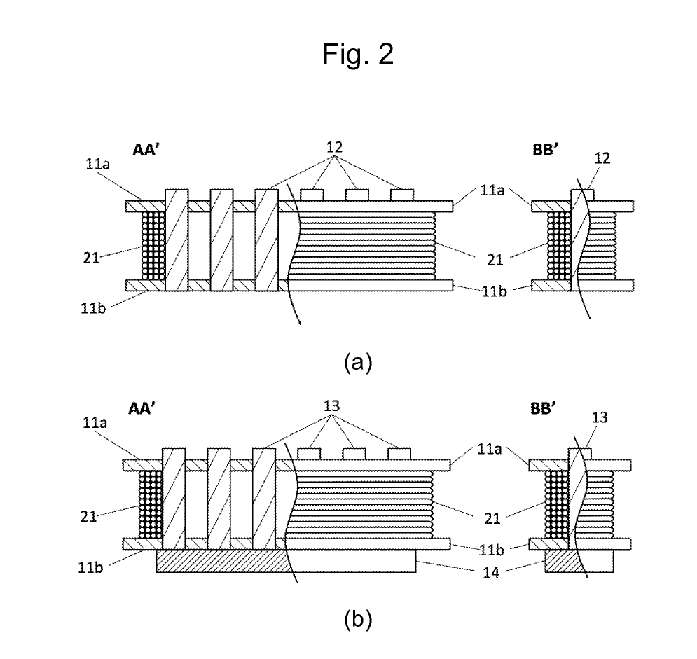

FIG. 1 shows a top view of a SC pickup placed underneath strings 10. The corresponding side views and partial cross-sectional diagrams are illustrated in FIG. 2. The pickup shown in the figures comprises of top bobbin plate 11a, bottom bobbin plate 11b, permanent magnet pole pieces 12 or ferromagnetic pole pieces 13, a magnet bar 14, and magnetic wire coil 21. Two bobbin plates, 11a and 11b, hold straight a set of pole pieces, 12 or 13, and the coil 21 is wound around the pole pieces 12 or 13. A magnetic field is generated by permanent magnet pole pieces 12 so that the vibration of the strings 10 is converted to electrical signal through the coil wire 21. When ferromagnetic pole pieces 13 are used, a magnetic bar 14 is situated under the assembly of pole pieces 13 and bottom bobbin plate 11b to generate a similar magnetic field.

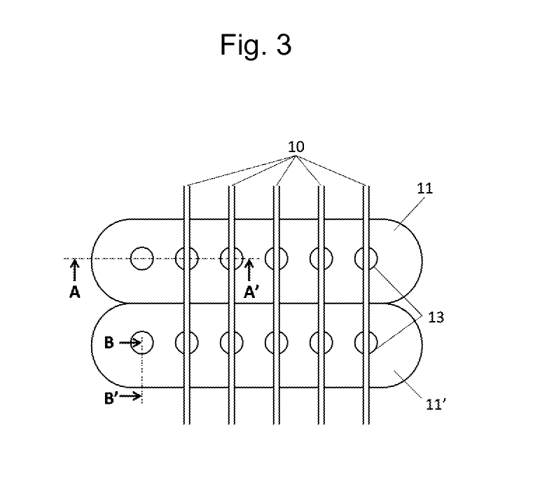

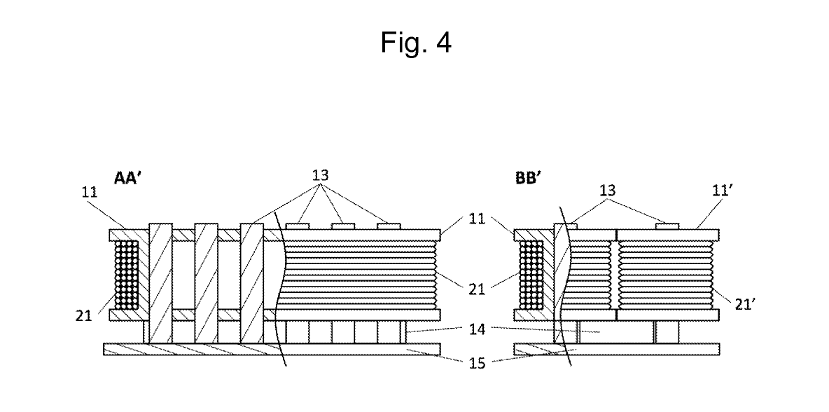

FIG. 3 shows a top view of a HB pickup placed underneath strings 10. The corresponding side view and partial cross-sectional diagram are illustrated in FIG. 4. Ferromagnetic pole pieces 13 are put inside and run through two bobbins, 11 and 11′, made of molded plastic. A magnet bar 14 is situated on the bottom side of the bobbins 11 and 11′. In the original PAF structure, one of the two bobbins, 11 or 11′, holds screw-type pole pieces. In this document all pole pieces 13 are described as straight cylinders for convenience sake in illustration of the present invention. The magnetic bar 14 is sandwiched by two rows of extended ferromagnetic pole pieces 13 such that two pole piece sets 13 of two bobbins, 11 and 11′, are induced with opposite magnetic polarities generating a closed circuit of magnetic field. Two wire coils, 21 and 21′, whose specifications can be identical or different, are wound around two bobbins, 11 and 11′, respectively.

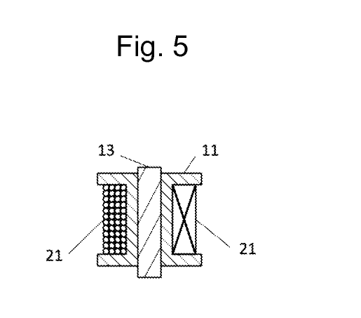

In order to illustrate the embodiment of the present invention more effectively a simplified diagram is used for coils. FIG. 5 shows a cross-sectional view across BB′ in FIG. 4 and includes a bobbin 11, a pole piece 13 and a coil 21. On the right-hand side the coil 21 is simplified as a box with two crossing lines. The following figures will use this simplified convention.

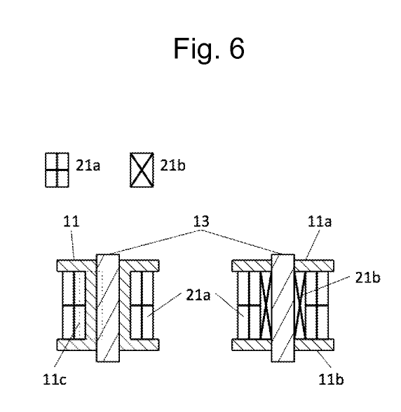

FIG. 6 illustrates the basic idea of this invention. The bobbin 11 for the HB pickup is generally made of molded plastic. It has holes for pole pieces 13 and those holes have a wall 11c with a certain thickness. The traditional SC pickup does not have such a wall 11c around pole pieces 12 or 13 because top and bottom plates, 11a and 11b, are separate parts and make up a bobbin shape by holding pole pieces 12 or 13 straight. In this invention the wall space of pole piece holes 11c is replaced with an inner coil wire 21b. Then an outer coil 21a is wound on top of the inner coil 21b. The outer coil 21a and the inner coil 21b are electrically connected in-phase to produce a SC pickup sound that is fuller than a sound from a typical coil-tapped HB pickup. The pole piece/bobbin/coil arrangements with one coil and dual coils (inner and outer coils) are referred to as one-coil assembly and dual-coil assembly, respectively, hereinafter.

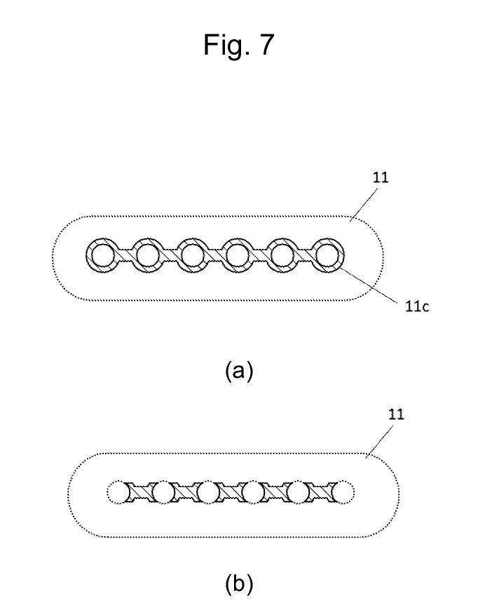

One way to eliminate the wall space 11c is to use separate top and bottom bobbin plates, 11a and 11b, combined with ferromagnetic pole pieces 13. It can be also realized with the molded plastic bobbin by eliminating the outward part of the pole piece hole wall 11c. FIG. 7(a) illustrates an example of pole piece hole wall structure 11c in a traditional molded plastic bobbin 11 and FIG. 7(b) shows an example of the bobbin 11, whose outward wall of pole piece holes was removed for embodiment of this invention. The bobbin shown in FIG. 7(b) can still be molded as one piece because the remaining wall structure can support top and bottom plates.

It is important to note that this invention is applicable to any HB pickups wherein two pole piece/bobbin/coil assemblies are situated side by side. For example, this invention can be embodied into the “blade” pickup invented by Lawrence (U.S. Pat. No. 4,364,295 granted in 1982). In case of the blade pickup, the pole piece 13 illustrated in FIG. 6 represents a cross-section of a ferromagnetic blade pole piece.

In other embodiments, the wall thickness may be reduced instead of being completely removed to obtain a specific type of SC pickup tone while maintaining the specification of the outer coil 11a. In traditional HB pickups, the pole piece hole wall thickness for cylinder-type pole pieces 13 is about 0.8 mm. Therefore, the pole piece hole wall thickness, or in more general term, the minimum distance between the outer surface of pole pieces 13 and the innermost wires of the inner coil 21b must be smaller than 0.8 mm.

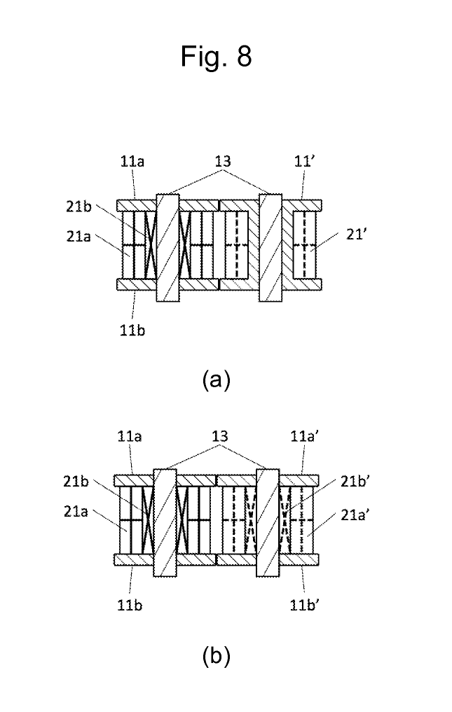

As illustrated in FIG. 8, one bobbin 11a/11b or both of bobbins, 11a/11b and 11a′/11b′, can be wound with dual coils in a HB pickup. Note that two bobbin plates 11a/11b or 11a′/11b′ can be separate top and bottom plates or a part of the single molded plastic piece as mentioned earlier. In case of the single dual-coil arrangement, the HB pickup sound is made by electrically connecting the outer coil 21a to the coil 21′ in the other bobbin 11′ out-of-phase. In case of the double dual-coil arrangement, a HB pickup sound is made by electrically connecting the outer coil 21a of one bobbin 11a/11b to the outer coil 21a′ of the other bobbin 11a′/11b′ out-of-phase. Each pair of dual coils, 21a/21b or 21a′/12b′, can be wound with its own specifications so that it should generate a unique SC pickup sound.

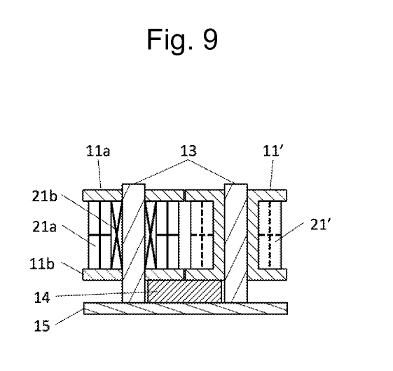

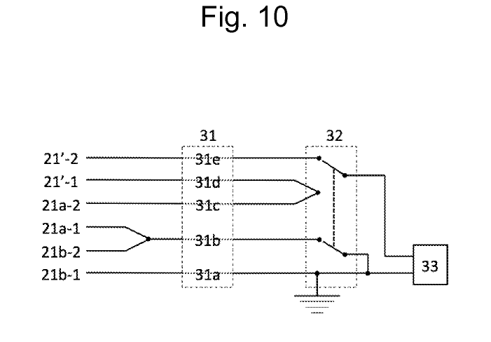

FIG. 9 shows a HB pickup structure employing one dual-coil assembly on the left side. This HB pickup has six outgoing wire tips due to the added inner coil 21b, whereas the traditional HB pickup has four outgoing lead wires. FIG. 10 illustrates an example of the coil wire tips, 21a-1, 21a-2, 21b-1, 21b-2, 21′-1 and 21′-2, connected to a shielded 4-conductor lead wire 31. The shielded 4-conductor lead wire 31 consists of ground 31a and four conductor wires, 31b, 31c, 31d and 31e. With the traditional HB pickup, four coil wire tips are soldered to those four conductor wires of the shielded lead wire 31. In the example illustrated in FIG. 10, two coil wires, 21a and 21′, used for a HB pickup sound are connected to the lead wire 31 the same way, in which four coil wire tips, 21a-1, 21a-2, 21′-1 and 21′-2, are soldered to four conductor wires, 31b, 31c, 31d and 31e, of the lead wire 31, respectively. The one tip of the inner coil 21b-1 is soldered to the ground wire 31a and the other tip 21b-2 to one tip of the outer coil 21a-1 electrically in-phase. The lead wire 31 is soldered onto a DPDT (Dual-Pole, Dual-Throw) toggle switch 32, such that the outer coil 21a of the dual-coil bobbin 11a/11b and the coil 21′ of the other bobbin 11′ are connected to an output circuit 33 at one side of the toggle switch 32 (upper toggle in FIG. 10) and the dual coils 21a/21b in series are connected to the same output circuit 33 at the other side of the toggle switch 32 (lower toggle in FIG. 10). More switches can be used to select tones from a HB pickup with double dual-coil assemblies or a combination of multiple HB pickups with dual-coil assemblies.

1: An electromagnetic pickup with hum-bucking configuration for stringed instruments, the electromagnetic pickup comprising two pole piece/bobbin/coil assemblies disposed side by side, wherein at least one of the two pole piece/bobbin assemblies consists of a bobbin, an inner coil wound around the bobbin, and an outer coil wound around the inner coil, wherein the inner coil and outer coil are electrically connected in-phase to obtain single coil pickup sound and the inner coil and the outer coil are disposed in two different spaces except for a lead wire for the inner coil drawn across the outer coil out of the bobbin for electrical connection.

2: An electromagnetic pickup of claim 1, wherein the said outer coil in one pole piece/bobbin assembly with dual coils is electrically connected to a coil in the other pole piece/bobbin assembly out-of-phase to obtain hum-bucking pickup sound.

3: An electromagnetic pickup of claim 1, wherein the innermost wires of the said inner coil is in contact with the pole piece surface.

4: An electromagnetic pickup of claim 1, wherein the innermost wires of the said inner coil is not in contact with the pole piece surface and the distance between the innermost wires of the said inner coil and the pole piece surface is less than 0.8 mm.

5: An electromagnetic pickup of claim 1 comprises two pole piece/bobbin assemblies disposed side by side, a bar magnet disposed under the two pole piece/bobbin assemblies, and a base plate disposed under the magnet, wherein the pole piece/bobbin assembly comprises a bobbin, a single or plural of pole pieces running through the bobbin, a single or plural of coils wound around the bobbin.
